(19) United States
(12) Patent Application Publication
(10) Pub. No.: US 2007/0217940 A1
(43) Pub. Date: Sep. 20, 2007

(54) PNEUMATIC TOOL WITH PRESSURE-STABILIZING CYLINDER

(75) Inventor: Jui-Sheng Chang, Wu-Jih Shiang (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: PNEUTECH MANUFACTUER CO., LTD., Wu-Jih Shiang (TW)

(21) Appl. No.: 11/307,646

(22) Filed: Feb. 15, 2006

(51) Int. Cl. F03C 2/00

(52) U.S. Cl. 418/270

(57) ABSTRACT

A pneumatic tool includes a shell, a cylinder positioned in the shell, a rotor eccentrically positioned in the cylinder for rotation and a shaft connected to the rotor and inserted from the interior to the exterior of the shell. The cylinder defines a space for receiving the rotor, a first intake related to a tightening mode, a first channel for communicating the first intake with the space, a second intake related to a slackening mode, a second channel for communicating the second intake with the space, at least one outlet in communication with the space and at least one pressure-releasing vent in communication with the space between the outlet and the first intake so that air vents from the pressure-releasing vent before venting from the outlet in the tightening mode. Blades are connected to the rotor includes so that air can push the blades so as to rotate the rotor.

### BACKGROUND OF INVENTION

1. Field of Invention

The present invention relates to pneumatic tools and, more particularly, to a pressure-stabilizing cylinder for pneumatic tools.

2. Related Prior Art

A conventional pneumatic tool includes a switch operable for controlling the flow rate of air, thus controlling torque. The switch is however an instable design and may fail to provide stable torque because of excessive tolerance in the fabrication thereof or excessively high pressure of the air.

Disclosed in Taiwanese Patent Publication No. 566300 is a cylinder set of a pneumatic tool. The cylinder set includes a cylinder 1 and a rotor 2 for rotation in the cylinder 1. The cylinder 1 eccentrically defines a space 16 so that it includes a thick portion and a thin portion. Intakes 11 and outlets 12 are defined in the thick portion of the cylinder 1 longitudinally. An outlet 13 is defined in the thin portion of the cylinder 1 transversely.

The rotor 2 includes blades 22. The rotor 2 is positioned in the space 16 eccentrically so that air chambers C grow larger toward the thin portion of the cylinder 1 and become smaller toward the thick portion of the cylinder 1. The air pushes the blades 22, thus rotating the rotor 2 fast and providing a large torque. Furthermore, the cost of the cylinder set is low.

There is however a trend toward a low torque for tightening fasteners and a high torque for slackening such fasteners. Such a low torque for tightening such fasteners protects them from damages. Such a high torque for slackening such fasteners ensures their quick release.

The present invention is therefore intended to obviate or at least alleviate the problems encountered in prior art.

### SUMMARY OF INVENTION

According to the present invention, a pneumatic tool includes a shell, a cylinder positioned in the shell, a rotor eccentrically positioned in the cylinder for rotation and a shaft connected to the rotor and inserted from the interior to the exterior of the shell. The cylinder defines a space for receiving the rotor, a first intake related to a tightening mode, a first channel for communicating the first intake with the space, a second intake related to a slackening mode, a second channel for communicating the second intake with the space, at least one outlet in communication with the space and at least one pressure-releasing vent in communication with the space between the outlet and the first intake so that air vents from the pressure-releasing vent before venting from the outlet in the tightening mode. Blades are connected to the rotor includes so that air can push the blades so as to rotate the rotor.

An advantage of the pneumatic tool of the present invention is to guarantee the integrity of a fastener by providing a small torque in the tightening mode and quickly slacken the fastener by providing a large torque in the slackening mode.

Other advantages and features of the present invention will become apparent from the following description referring to the drawings.

### BRIEF DESCRIPTION OF DRAWINGS

The present invention will be described through detailed illustration of the preferred embodiment referring to the drawings.

FIG. 1 is a perspective view of a pneumatic tool according to the preferred embodiment of the present invention.

FIG. 2 is an exploded view of a pressure-stabilizing cylinder of the pneumatic tool shown in FIG. 1.

FIG. 3 is a side view of the pressure-stabilizing cylinder of FIG. 2.

FIG. 4 is a front view of the pressure-stabilizing cylinder of FIG. 2 in a slackening mode.

FIG. 5 is a front view of the pressure-stabilizing cylinder of FIG. 2 in a tightening mode.

FIG. 6 is a cross-sectional view of the pressure-stabilizing cylinder along a line 6-6 in FIG. 3.

### DETAILED DESCRIPTION OF PREFERRED EMBODIMENT

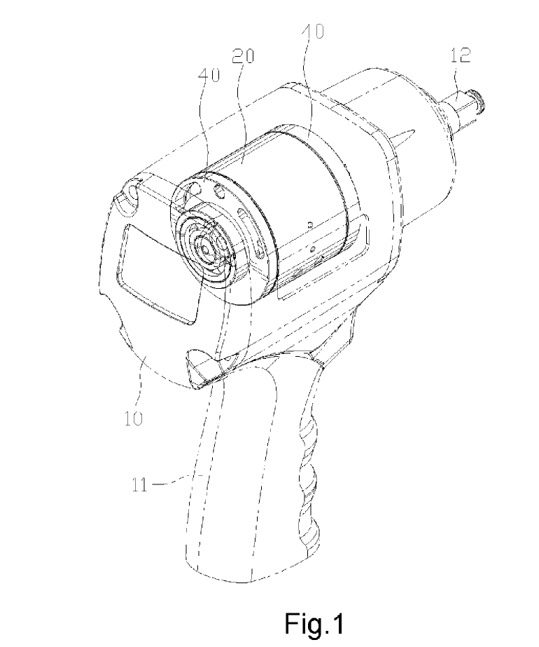

Referring to FIG. 1, there is shown a pneumatic tool according to the preferred embodiment of the present invention. The pneumatic tool includes a shell 10, a cylinder 20 positioned in the shell 10 and a rotor 30 for rotation in the cylinder 20.

The shell 10 includes a handle 11 for handling by a user.

A shaft 12 is inserted from the interior to the exterior of the shell 10. The shaft 12 includes an end connected to the rotor 30 and an opposite end for connection to a bit.

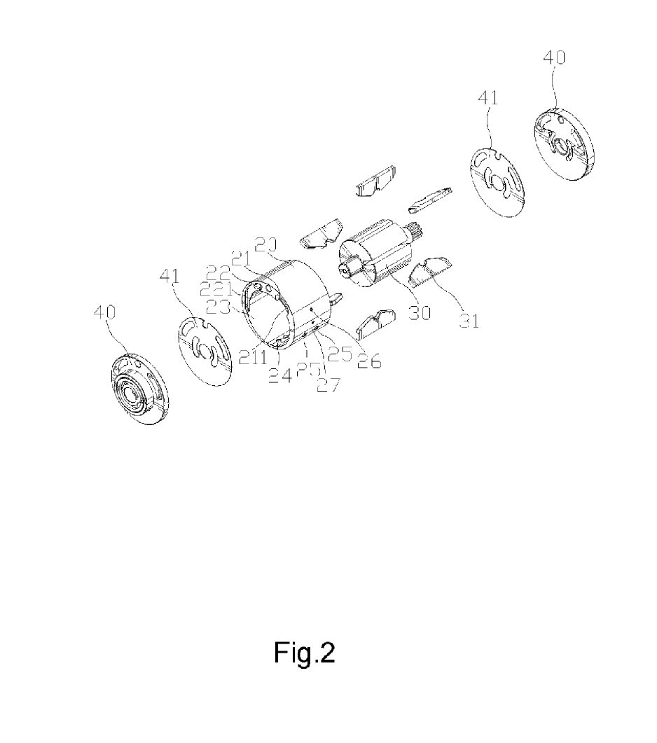

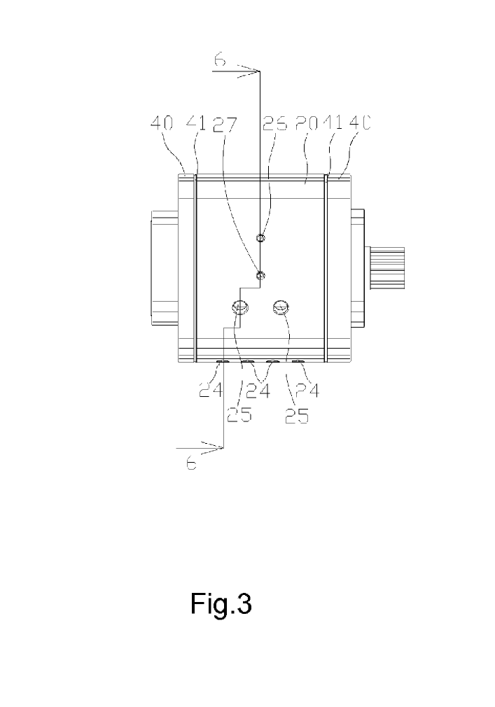

Referring to FIGS. 2 and 3, the cylinder 20 includes two ends that are made open and closed by means of two covers 40. A wearing-proof sheet 41 is provided between each of the covers 40 and related one of the ends of the cylinder 20.

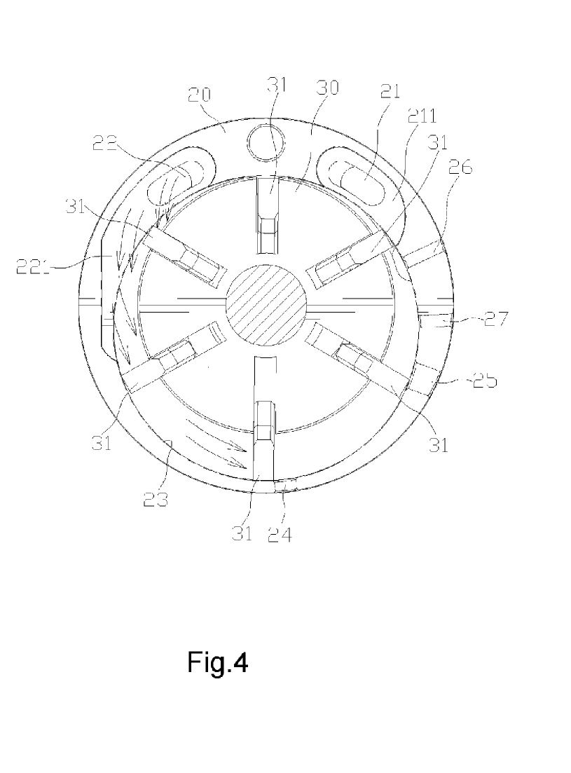

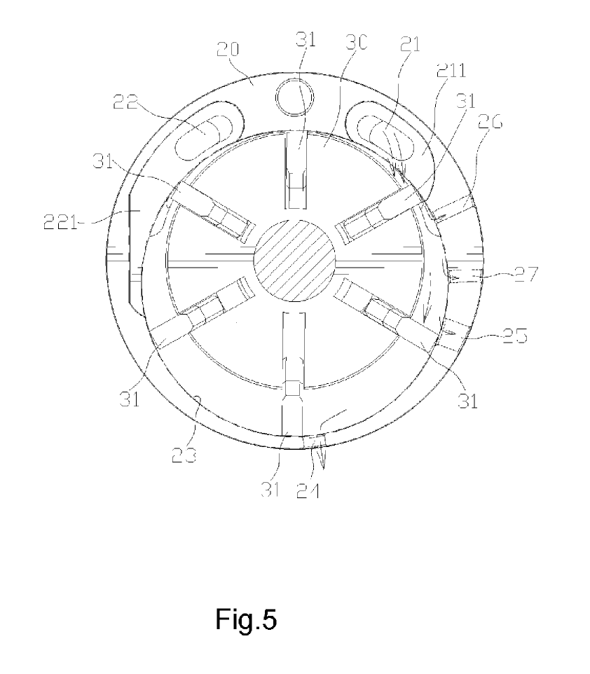

The cylinder 20 includes a space 23 eccentrically defined therein so that the cylinder 20 includes a thick portion and a thin portion. Defined longitudinally in the thick portion of the cylinder 20 is a first intake 21 corresponding to a tightening mode. Defined longitudinally in the thick portion of the cylinder 20 is a second intake 22 corresponding to a slackening mode. The first intake 21 is in communication with the space 23 through a first channel 211 defined in one of the ends of the cylinder 20. The second intake 22 is in communication with the space 23 through a second channel 221 defined in the end of the cylinder 20. The interface between the first channel 211 and the space 23 is smaller than the interface between the second channel 221 and the space 23 referring to FIGS. 4 and 5.

The cylinder 20 includes several outlets 24 transversely defined in the thin portion thereof. In the preferred embodiment, the outlets 24 are closer to the first intake 21 than to the second intake 22.

Transversely defined in the cylinder 20 are several pressure-releasing vents 25 between the outlets 24 and the first intake 21. Air goes through the pressure-releasing vents 25 at a lower rate than through the outlets 24.

Transversely defined in the cylinder 20 is a first pressure-stabilizing vent 26 between the pressure-releasing vents 25 and the first intake 21. Air goes through the first pressure-stabilizing vent 26 at a lower rate than through the pressure-releasing vents 25.

Between the first pressure-stabilizing vent 26 and the first intake 21, a second pressure-stabilizing vent 27 is transversely defined in the cylinder 20. Air does not go through the first pressure-stabilizing vent 26 at a higher rate than through the second pressure-stabilizing vent 27. Preferably, air goes through the pressure-stabilizing vents 27 and 26 at a same rate. Air goes through the second pressure-stabilizing vent 27 at a lower rate than through the pressure-releasing vent 25.

The rotor 30 includes several blades 31. As shown, there are six blades 31. The blades 31 are installed in a conventional manner. Air can push the blades 31 so as to rotate the rotor 30.

Referring to FIG. 4, the pneumatic tool is in the slackening mode. Air goes into the space 23 from the second intake 22 through the second channel 221. The interface between the second channel 221 and the space 23 extends for about 90 degrees so that air travels at a high rate. Before venting from the outlets 24, the air pushes three of the blades 31. Therefore, the air provides a large torque to the rotor 30.

Referring to FIG. 5, the pneumatic tool is in the tightening mode. Air goes into the space 23 from the first intake 21 through the first channel 211. The interface between the first channel 211 and the space 23 extends for about 30 degrees so that air travels at a low rate. Before venting from the outlets 24, the air pushes two of the blades 31. Hence, the air provides a small torque to the rotor 30.

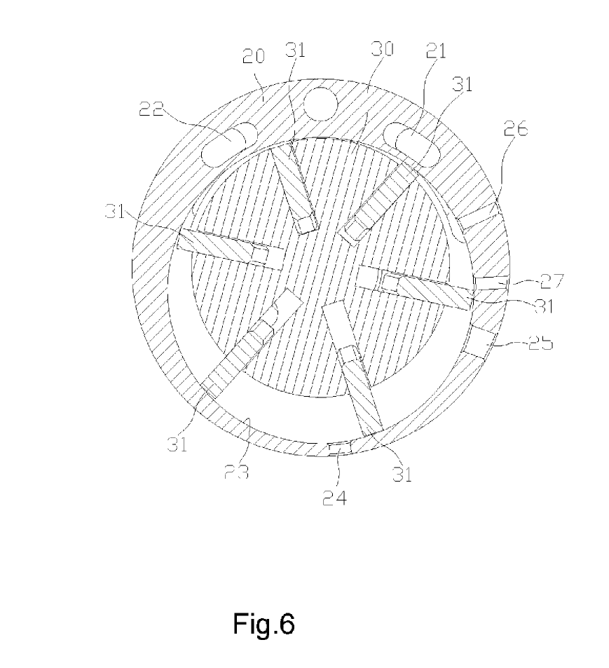

Referring to FIG. 6, in the tightening mode, a portion of the air vents from the pressure-stabilizing vents 26 and 27 before venting from the outlets 24. If the pressure of the air is too high, the pressure-stabilizing vents 26 and 27 can release some of the air from the space 23 so as to lower the pressure. Thus, it is ensured that the air provides a low torque to the rotor 30 in the tightening mode. Therefore, the integrity of a fastener driven with the pneumatic tool is guaranteed.

The pneumatic tool of the present invention includes at least three advantageous features. Firstly, the interface between the first channel and the space is smaller than the interface between the second channel and the space so that the pneumatic tool provides a smaller torque to a fastener in the tightening mode than in the slackening mode.

Secondly, the pressure-releasing vents are defined between the first intake and the outlets so as to ensure that the pneumatic tool provides a smaller torque to a fastener in the tightening mode than in the slackening mode.

Thirdly, the pressure-stabilizing vents are defined between the first intake and the pressure-releasing vents so as to ensure that the pneumatic tool provides a smaller torque to a fastener in the tightening mode than in the slackening mode even if a surge of the pressure emergences in the tightening mode.

The present invention has been described through the illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A pneumatic tool comprising:
a shell;
a cylinder comprising a space defined therein, a first intake defined therein related to a tightening mode, a first channel for communicating the first intake with the space, a second intake defined therein related to a slackening mode, a second channel for communicating the second intake with the space, at least one outlet in communication with the space and at least one pressure-releasing vent in communication with the space between the outlet and the first intake so that air vents from the pressure-releasing vent before venting from the outlet in the tightening mode;
a rotor eccentrically positioned in the space for rotation, the rotor comprising a plurality of blades connected thereto so that air can push the blades so as to rotate the rotor; and
a shaft connected to the rotor and inserted from the interior to the exterior of the shell.

2. The pneumatic tool according to claim 1 wherein the first and second intakes are longitudinally defined in the cylinder.

3. The pneumatic tool according to claim 2 wherein the first and second channels are defined in an end the cylinder.

4. The pneumatic tool according to claim 1 wherein the interface between the first channel and the space is larger than the interface between the second channel and the space.

5. The pneumatic tool according to claim 1 wherein the cylinder comprises a first pressure-stabilizing vent in communication with the space between the pressure-releasing vent and the first intake.

6. The pneumatic tool according to claim 5 wherein the air goes through the first pressure-stabilizing vent at a lower rate than through the pressure-releasing vent.

7. The pneumatic tool according to claim 5 wherein the cylinder comprises a second pressure-stabilizing vent in communication with the space between the first pressure-stabilizing vent and the pressure-releasing vent.

8. The pneumatic tool according to claim 7 wherein the air does not go through the first pressure-stabilizing vent at a higher rate than through the second pressure-stabilizing vent.

9. The pneumatic tool according to claim 8 wherein the air goes through the first and second pressure-stabilizing vents at a same rate.

10. The pneumatic tool according to claim 8 wherein the air goes through the second pressure-stabilizing vent at a lower rate than through the pressure-releasing vent.

11. The pneumatic tool according to claim 1 wherein the cylinder comprises a plurality of pressure-releasing vents.

12. The pneumatic tool according to claim 1 wherein the outlet is closer to the first intake than to the second intake.

13. The pneumatic tool according to claim 1 wherein the cylinder comprises a plurality of outlets.

14. The pneumatic tool according to claim 1 wherein the cylinder comprises two open ends.

15. The pneumatic tool according to claim 1 comprising two covers for closing the open ends of the cylinder.

16. The pneumatic tool according to claim 14 comprising two wearing-proof sheets each positioned between related one of the covers and related one of the ends of the cylinder.
